(19) United States
(12) Patent Application Publication
(10) Pub. No.: US 2015/0043658 A1
(43) Pub. Date: Feb. 12, 2015

(54) LOWER MEMORY BANDWIDTH VIDEO NON UNIFORMITY CORRECTION TECHNIQUE

(71) Applicant: Raytheon Company, Waltham, MA (US)

(72) Inventor: Philip M. Mayner, Goleta, CA (US)

(73) Assignee: Raytheon Company, Waltham, MA (US)

(21) Appl. No.: 13/960,122

(22) Filed: Aug. 6, 2013

(51) Int. Cl. H04N 19/89

(52) U.S. Cl. CPC H04N 19/00933
USPC 375/240.27

(57) ABSTRACT

A system for correcting non-uniformity in a video detector. In one embodiment, a system for correcting non-uniformity in a video detector having an array of sensors referred to as pixels stores compressed gain terms and compressed offset terms in a non-uniformity memory (105). These gain terms and offset terms are generated in a calibration procedure, and are calculated to correct for non-uniformity in the video detector. The gain terms and offset terms are decompressed by a decompression block (125) and used to correct raw video data generated by the detector, forming corrected video. The storage of the gain terms and correction terms in compressed form reduces both the memory capacity requirements and the data bus bandwidth required.

### BACKGROUND

1. Field

One or more aspects of embodiments according to the present invention relate to video uniformity correction and more particularly to a system and method for reducing memory bandwidth requirements in a system for performing video uniformity correction.

2. Description of Related Art

Array video detectors such as charge-coupled devices (CCDs) and video detectors (FPAs) include arrays of sensors referred to as pixels, which are read out repeatedly, e.g., at video rates in the range of 30 to 60 frames per second. Imperfections in such a detector, as a result of manufacturing process imperfections or aging, may result in the pixels in the detector having different gains and offsets, where the gain of a pixel is the ratio of the magnitude of the electrical signal produced by the pixel to the magnitude of the optical signal, and the offset is the magnitude of the electrical signal in the absence of an optical signal.

### SUMMARY

In one embodiment, a system for correcting non-uniformity in a video detector having an array of sensors referred to as pixels stores compressed gain terms and compressed offset terms in a non-uniformity memory. These gain terms and offset terms are generated in a calibration procedure, and are calculated to correct for non-uniformity in the video detector. The gain terms and offset terms are decompressed and used to correct raw video data generated by the detector, forming corrected video. The storage of the gain terms and correction terms in compressed form reduces both the memory capacity requirements and the data bus bandwidth required.

According to an embodiment of the present invention there is provided a system for correcting non-uniformity in raw video data provided by a video detector, the system including: a memory for storing compressed correction terms; a processing unit for performing decompression of the compressed correction terms to produce reconstituted correction terms; and a processing unit for applying reconstituted correction terms to raw video data to produce corrected video data.

In one embodiment, the processing unit for performing decompression of the compressed correction terms is configured to perform lossless decompression of the compressed correction terms.

In one embodiment, the processing unit for performing decompression of the compressed correction terms is configured to perform Rice decompression of the compressed correction terms.

In one embodiment, the raw video data includes a stream of raw data items, each raw data item including 14 bits.

In one embodiment, the processing unit for performing decompression of the compressed correction terms to produce reconstituted correction terms is configured to operate at a rate of more than 10 million data items per second, and the processing unit for applying reconstituted correction terms to raw video data to produce corrected video data is configured to operate at a rate of more than 10 million data items per second.

According to an embodiment of the present invention there is provided a system including a video detector configured to generate raw video data; and a system for correcting non-uniformity in the raw video data.

According to an embodiment of the present invention there is provided a method for generating corrected video data, including: generating a plurality of correction terms; compressing, by a processing unit, the correction terms to form compressed correction terms; generating raw video data; decompressing, by a processing unit, the compressed correction terms to form reconstituted correction terms; and correcting the raw video data, by a processing unit, using the reconstituted correction terms, to form the corrected video data.

In one embodiment, the generating of the plurality of correction terms includes performing a controlled exposure.

In one embodiment, the generating of the plurality of correction terms includes performing two flat-field exposures and identifying gain terms and offset terms which, when used to correct the raw video obtained for the two flat-field exposures, results in corrected video that is substantially flat for each exposure.

In one embodiment, the compressing, by a processing unit, the correction terms to form compressed correction terms, includes compressing the correction terms with a lossless compression algorithm.

In one embodiment, the compressing of the correction terms with a lossless compression algorithm includes compressing the correction terms with Rice compression.

In one embodiment, the reconstituted correction terms include a reconstituted gain term.

In one embodiment, the reconstituted correction terms include a reconstituted offset term.

In one embodiment, the raw video data includes a raw video data item and wherein the correcting of the raw video data, by a processing unit, using the reconstituted correction terms, to form the corrected video data includes multiplying the raw video data item by a reconstituted gain term to form a gain corrected video data item.

In one embodiment, the correcting of the raw video data, by a processing unit, using the reconstituted correction terms, to form the corrected video data includes adding an offset term to the gain corrected video data item to form a corrected video data item.

In one embodiment, the raw video data includes a raw video data item and wherein the correcting of the raw video data, by a processing unit, using the reconstituted correction terms, to form the corrected video data includes adding a reconstituted offset term to the raw video data item to form an offset corrected video data item.

In one embodiment, the correcting of the raw video data, by a processing unit, using the reconstituted correction terms, to form the corrected video data, includes multiplying the offset corrected video data item by a gain term to form a corrected video data item.

### BRIEF DESCRIPTION OF THE DRAWINGS

Features, aspects, and embodiments are described in conjunction with the attached drawings, in which:

FIG. 1 is a block diagram of a system for correcting raw video data according to an embodiment of the present invention; and

FIG. 2 is a flow chart illustrating a method for correcting raw video data according to an embodiment of the present invention.

### DETAILED DESCRIPTION

The detailed description set forth below in connection with the appended drawings is intended as a description of exemplary embodiments of a system and method for reduced memory bandwidth video non-uniformity correction provided in accordance with the present invention and is not intended to represent the only forms in which the present invention may be constructed or utilized. The description sets forth the features of the present invention in connection with the illustrated embodiments. It is to be understood, however, that the same or equivalent functions and structures may be accomplished by different embodiments that are also intended to be encompassed within the spirit and scope of the invention. As denoted elsewhere herein, like element numbers are intended to indicate like elements or features.

It may be advantageous to correct raw video data generated by an array video detector, by multiplying each data item in the raw video data by a correction term referred to as a gain term and adding to each data item a correction term referred to as an offset term. Raw data rates from large array detectors may be high, however, which may result in a requirement for high memory bandwidth to supply the correction terms for real-time application of corrections. Thus, there is a need for a system and method for reducing the memory bandwidth requirements in a video correction system.

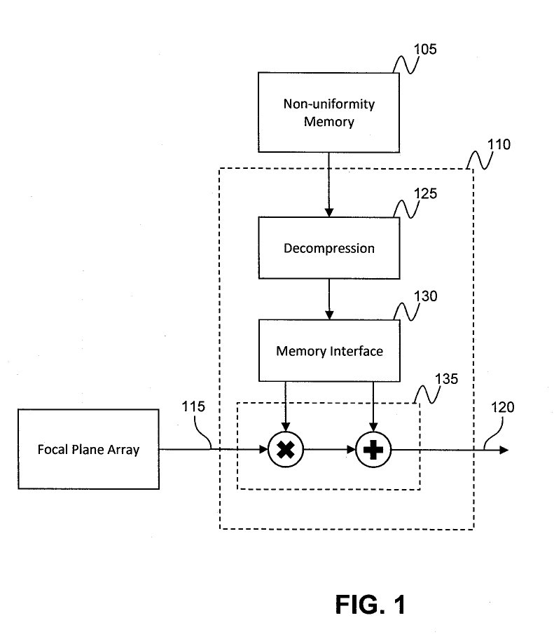

Referring to FIG. 1, in one embodiment compression and decompression are used to reduce data rates and storage requirements in a system for correcting raw video data generated by a video detector. In a calibration procedure prior to operation, the gain and offset of each pixel of the video detector are measured, and correction terms, for correcting for detector non-uniformity, i.e., pixel-to-pixel gain and offset variations, are calculated. The correction terms for each pixel are then used to correct raw video data received from the pixel in operation. The same correction terms may be used for the pixel throughout the life of the detector, or, if the detector is recalibrated at some point during its operating life, new correction terms may be substituted. In one embodiment the detector may be recalibrated in operation. For example a camera containing the detector may be equipped with a shutter which may, during operation, briefly block light from the scene being observed to allow a calibration to be performed. Such a calibration process performed during operation may be advantageous if the detector response is expected to change during operation, e.g., as a result of changes in the temperature of the detector.

The correction terms are, in one embodiment, compressed and programmed into data storage referred to as non-uniformity memory 105. This memory is referred to as “non-uniformity” memory because it is used to store corrections terms for correcting detector non-uniformity. In operation, a correction unit 110 reads compressed correction terms out of the non-uniformity memory 105, decompresses them to form reconstituted correction terms. Then, from the raw video data stream received at a raw video input 115, and using the reconstituted correction terms, the system forms a corrected video data stream and outputs it at a corrected video output 120. The correction unit 110 includes a decompression block 125 which generates reconstituted correction terms from the compressed correction terms and feeds them, through a memory interface 130, to a correction block 135, which performs the correction of the video data.

The correction block 135 and the decompression block 125 may be processing units. The term “processing unit” is used herein to include any combination of hardware, firmware, and software, employed to process data or digital signals. Processing unit hardware may include, for example, application specific integrated circuits (ASICs), general purpose or special purpose central processing units (CPUs), digital signal processors (DSPs), graphics processing units (GPUs), and programmable logic devices such as field programmable gate arrays (FPGAs). Components of a processing unit may themselves be processing units, and, for example, the correction unit 110, which contains the correction block 135 and the decompression block 125, may also be a processing unit. Thus, in one embodiment the decompression may be performed by a first processing unit and the correcting may be accomplished by a second processing unit, which may or may not be contained in the first processing unit. In another embodiment a single processing unit may perform both the decompression and the correcting. The memory interface may contain storage such as a first-in-first-out (FIFO) structure, to avoid a requirement that retrieval and decompression of compressed correction terms be precisely synchronized with the calculations in which the corrections are applied to the raw video data.

Raw video data may be received from a video camera including a video detector. The array of pixels in the video detector may, for example, be a focal plane array and the pixels may be read out one at a time, by e.g., switching transistors in the array to connect the pixels, one at a time, to a shared analog output of the array, and converting the voltage at the analog output with an analog to digital (A/D) converter. This voltage, which may be referred to as an analog pixel value, may be a function of the amount of light, e.g., the number of photons, detected by the pixel during the previous frame or exposure of the video detector. In particular, the analog voltage may be approximately equal to a pixel gain times the sum of the number of photons detected and a pixel offset. Under an alternate, similar definition of pixel gain and pixel offset, the analog voltage may be approximately equal to a pixel offset plus a pixel gain times the number of photons detected. The conversion operations or sample and hold operations of the A/D converter may be synchronized with the connecting of the pixels to the shared analog output, so that each A/D conversion operation corresponds to one of the pixels being read out.

The video data stream may consist of a sequence of data values, each data value being the result of a conversion, by the A/D converter, of an analog pixel value to a raw digital pixel value. The pixel gain and pixel offset may vary from pixel to pixel on the video detector, for example as a result of variations in the unit cell capacitance of pixels in the array, producing undesired distortion in the video data stream. This distortion may be mitigated if the pixel gain and pixel offset are known for each pixel in the video detector. In this case, each data item, e.g., each output word generated by the A/D converter, in the raw video data stream may be multiplied by a correction term referred to as a gain term, and each data item in the raw video data stream may have added to it a correction term referred to as an offset term. The gain term and offset term may be chosen to cause the video data stream to be more nearly independent of, i.e., unaffected by, variations in pixel gain and pixel offset across the video detector.

The gain terms and phase terms may be determined in a calibration procedure including controlled exposures or similar measurements in which, for example, the video detector may be exposed to a flat field, e.g., a source of illumination that results in a known, approximately equal photon flux on each pixel of the array, or a dark exposure, in which the photon flux on each pixel is approximately zero. An alternate pair of measurements may include two flat-field exposures with the same source of illumination, and with different exposure times. The data from these measurements may then be used to calculate gain terms and offset terms that, when applied, will approximately correct for any variations in pixel gain and pixel offset, i.e., gain terms and offset terms that, for flat field exposures, will result in corrected video images that are substantially flat. These gain terms and offset terms may then be stored in memory, e.g., in nonvolatile memory, and retrieved from memory as needed in operation to apply the gain correction and offset correction to the raw video data.

For a large video detector the quantity of memory required to store the gain terms and offset terms may be significant, and the data bus capacity, i.e., the data bus bandwidth required to deliver the gain terms and offset terms to the correction block 135 at video rates, may also be large. These data, however, may have properties allowing all or nearly all of the information they contain to be represented by a smaller number of bits, resulting in an easing of the requirements both on memory capacity and data bus bandwidth. For example, the gain terms may all be relatively close to 1, and they may differ little from pixel to pixel, with the exception, perhaps, of a few pixels having pixel gain significantly different from 1. Similarly nearly all of the offset terms may be close to 0.

Data compression may therefore be used to store all of the gain terms and offset terms in a smaller memory, and to reduce the data bus bandwidth requirements. In one embodiment, after a calibration procedure is performed and the gain terms and offset terms are generated, the gain terms and offset terms may be compressed using a compression algorithm, to form compressed gain terms and offset terms. These are stored in non-uniformity memory 105. During operation, the gain terms and offset terms are retrieved from non-uniformity memory 105, decompressed by the decompression block 125 to create reconstituted gain terms and reconstituted offset terms, and the reconstituted gain terms and reconstituted offset terms are then fed, through a memory interface 130, to the correction block 135. In the correction block 135 the gain terms and offset terms are used to correct the raw video data to produce corrected video data. In the correction block 135, each raw video data item may first be multiplied by a gain term and the resulting product may then have added to it an offset term, as illustrated in FIG. 1, or the raw video data item may first have added to it an offset term and the resulting sum may then be multiplied by a gain term. Because the non-uniformity memory 105 stores compressed gain and phase terms, both the data storage requirements and the data bus bandwidth requirements are less demanding than they would be if uncompressed gain terms and offset terms were stored.

The compression algorithm used may be any suitable compression algorithm known to those skilled in the art. For example, a lossless compression algorithm may be used, i.e., a compression algorithm ensuring that each reconstituted gain term is equal to the corresponding uncompressed gain term and that each reconstituted offset term is equal to the corresponding uncompressed offset term. Rice compression, which may also be referred to as Golomb coding, may for example be used to perform lossless compression. The corresponding decompression, used to reconstitute the gain terms and offset terms, is referred to herein as Rice decompression. In other embodiments lossy compression may be used. In this case each reconstituted gain term may differ slightly from the corresponding uncompressed gain term and each reconstituted offset term may differ slightly from the corresponding uncompressed offset term. Lossy compression may provide a higher compression ratio than lossless compression. The lossy compression algorithm used may be any suitable compression algorithm known to those skilled in the art. Compression and decompression may be performed on data blocks of a size which may be selected to provide an acceptable compression ratio while not requiring an unacceptably large buffer or excessive processing power in the processing unit performing the decompression. In one embodiment, the data are compressed and decompressed one 14-bit word at a time.

In one embodiment, the pixels in an 8,000×8,000 pixel array, i.e., a pixel array having 64,000,000 pixels, may be read out 16 pixels at a time, through 16 parallel analog outputs referred to as taps, each of which is configured to read a portion, e.g., one sixteenth, of the entire array. Each analog output may then be sampled by an array of 128 analog to digital converters (A/D converters), each A/D array fed by an analog multiplexer with one analog input and 128 analog outputs. The analog multiplexer may connect the analog input to each of the A/D converters in turn, during a time interval long enough for the A/D converter to obtain a sample of the analog signal, e.g., in a sample-and-hold circuit. The switching of the analog multiplexer may be synchronized with the reading out of data from the pixels in the array, so that each time an A/D converter receives a new analog sample, it corresponds to the photon flux incident on a pixel of the array during a frame.

In this example if the video frame rate is 40 frames per second, and each A/D converters generates a 14-bit output value, i.e., a 14-bit raw video data item, for each conversion, then the total data rate is approximately 2.6 billion 14-bit words per second. Assuming that the gain terms and offset terms are also 14-bit words, the total data rate needed for the correction terms, if compression is not used, is 5.1 billion 14-bit words per second, or 8.3 gigabytes (GB) per second. To supply data at this rate, 24 memories operating at 400 megabytes per second (MB/s) would be required. The use of compression may reduce these requirements by a factor of approximately 2, as a result of which 12 memories may be sufficient. This may be especially advantageous in applications, such as in portable units, in which compactness is an important feature.

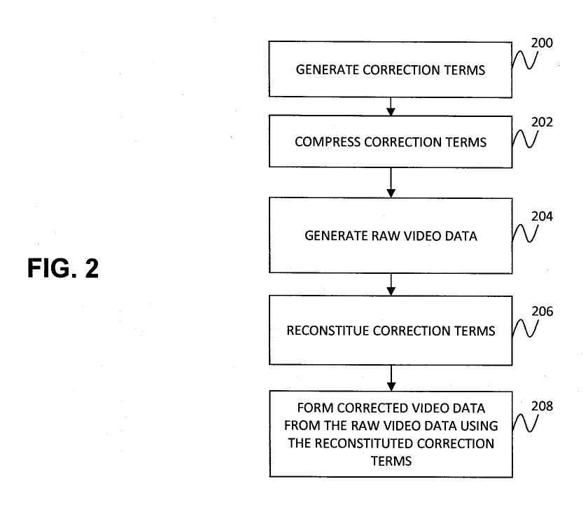

A method of performing corrections for non-uniformity according to an embodiment of the present invention is illustrated in FIG. 2. In step 200, correction terms are generated using a calibration procedure, and the correction terms are compressed in step 202. In operation, raw video data are generated by a video detector in step 204, the compressed correction terms are read from non-uniformity memory 105, and decompressed, in step 206, to form reconstituted correction terms, and the reconstituted correction terms are used, in step 208, to correct the raw video data, to form corrected video data.

Although limited embodiments of a system and method for reduced memory bandwidth video non-uniformity correction have been specifically described and illustrated herein, many modifications and variations will be apparent to those skilled in the art. For example, a system constructed according to embodiments of the present invention may operate with video data at any frame rate, including 30 Hz, 40 Hz, 60 Hz, and other frame rates, and with raw video data having an arbitrary pixel size in bits, e.g., 8 bits, 14 bits, 16 bits, or any other number of bits. The correction applied need not be limited to a gain term and an offset term but may be an arbitrary function taking correction terms as parameters, such as a quadratic (e.g., written in the form ax̂2+bx+c) which includes an offset term, a gain term, and a quadratic term. The function may also be a piecewise linear function, or any other function which operates on the raw video data to produce corrected video data. Accordingly, it is to be understood that the system and method for reduced memory bandwidth video non-uniformity correction employed according to principles of this invention may be embodied other than as specifically described herein. The invention is also defined in the following claims, and equivalents thereof.

What is claimed is:

1. A system for correcting non-uniformity in raw video data provided by a video detector, the system comprising:
a memory storing compressed correction terms;
a processing unit performing decompression of the compressed correction terms to produce reconstituted correction terms; and
a processing unit for correcting the raw video data, using the reconstituted correction terms, to produce corrected video data.

2. The system of claim 1, wherein the processing unit for performing decompression of the compressed correction terms is configured to perform lossless decompression of the compressed correction terms.

3. The system of claim 2, wherein the processing unit for performing decompression of the compressed correction terms is configured to perform Rice decompression of the compressed correction terms.

4. The system of claim 1, wherein the raw video data comprises a stream of raw data items, each raw data item comprising 14 bits.

5. The system of claim 4, wherein the processing unit for performing decompression of the compressed correction terms to produce reconstituted correction terms is configured to operate at a rate of more than 10 million data items per second, and the processing unit for applying reconstituted correction terms to raw video data to produce corrected video data is configured to operate at a rate of more than 10 million data items per second.

6. The system of claim 1, comprising a video detector configured to generate the raw video data.

7. A method for generating corrected video data, comprising:
generating a plurality of correction terms;
compressing, by a processing unit, the correction terms to form compressed correction terms;
generating raw video data;
decompressing, by a processing unit, the compressed correction terms to form reconstituted correction terms; and
correcting the raw video data, by a processing unit, using the reconstituted correction terms, to form the corrected video data.

8. The method of claim 7, wherein the generating of the plurality of correction terms comprises performing a controlled exposure.

9. The method of claim 8, wherein the generating of the plurality of correction terms comprises performing two flat-field exposures and identifying gain terms and offset terms which, when used to correct the raw video obtained for the two flat-field exposures, results in corrected video that is substantially flat for each exposure.

10. The method of claim 7, wherein the compressing, by a processing unit, of the correction terms, to form compressed correction terms, comprises compressing the correction terms with a lossless compression algorithm.

11. The method of claim 10, wherein the compressing of the correction terms with a lossless compression algorithm comprises compressing the correction terms with Rice compression.

12. The method of claim 7, wherein the reconstituted correction terms comprise a reconstituted gain term.

13. The method of claim 7, wherein the reconstituted correction terms comprise a reconstituted offset term.

14. The method of claim 7, wherein the raw video data comprises a raw video data item and wherein the correcting of the raw video data, by a processing unit, using the reconstituted correction terms, to form the corrected video data, comprises multiplying the raw video data item by a reconstituted gain term to form a gain corrected video data item.

15. The method of claim 14, wherein the correcting of the raw video data, by a processing unit, using the reconstituted correction terms, to form the corrected video data, comprises adding an offset term to the gain corrected video data item to form a corrected video data item.

16. The method of claim 7, wherein the raw video data comprises a raw video data item and wherein the correcting of the raw video data, by a processing unit, using the reconstituted correction terms, to form the corrected video data, comprises adding a reconstituted offset term to the raw video data item to form an offset corrected video data item.

17. The method of claim 16, wherein the correcting of the raw video data, by a processing unit, using the reconstituted correction terms, to form the corrected video data, comprises multiplying the offset corrected video data item by a gain term to form a corrected video data item.
